(19) United States
(12) Patent Application Publication
(10) Pub. No.: US 2020/0401113 A1
(43) Pub. Date: Dec. 24, 2020

(54) DETERMINING OPTIMAL MATERIAL AND/OR MANUFACTURING PROCESS

(71) Applicant: HITACHI, LTD., Tokyo (JP)

(72) Inventors: Wei YUAN, Farmington Hills, MI (US); Lili ZHENG, Farmington Hills, MI (US); Jiye WANG, Farmington Hills, MI (US); Hiroshi NAKANO, Tokyo (JP)

(21) Appl. No.: 16/448,020

(22) Filed: Jun. 21, 2019

(51) Int. Cl. G05B 19/4155; G06N 20/00

(52) U.S. Cl. CPC G05B 19/4155; G05B 2219/35021; G06N 20/00

(57) ABSTRACT

In some examples, a computing device may receive, from a user device, inputs specifying a performance parameter and at least one of a material or manufacturing process. The computing device may determine one or more manufacturing processes corresponding to the inputs, and may determine at least one of a machine learning model or a simulation model corresponding to at least one manufacturing process related to the inputs. The computing device may input information related to a plurality of candidate materials into the machine learning model or simulation model to determine a predicted property of the respective candidate materials related to the performance parameter. In addition, the computing device may compare the predicted properties with each other to select at least one of a selected material or a selected manufacturing process, and may send, to the user device, information related to the selected material or manufacturing process.

### BACKGROUND

Raw materials, such as metals, plastics, ceramics, and so forth, are traded in every field of the manufacturing industry, both domestically and internationally. When selecting a material supplier or other supplier of a material to use for producing a product, an engineer and/or manufacturer may consider factors such as material properties, quality, reliability, stability, price, and availability of the material, such as for delivery to the factory where the material is processed. Determining an optimal material (e.g., desired performance at lowest cost and available on time) can be a challenge since the quality of the final product may be directly related to the raw materials used and the manufacturing processes applied during production.

Conventionally, determining the raw material and/or the manufacturing processes to use are mostly based on experience and technological know-how, which can vary greatly among engineers and manufacturers. As a result, products may be manufactured having a high chance of not using an optimal material, and may possibly even use an improper material or process.

### SUMMARY

Some implementations include arrangements and techniques for automated selection of a material or manufacturing process for a product. For example, a computing device may receive, from a user device, inputs specifying a performance parameter and at least one of a material or manufacturing process. The computing device may determine one or more manufacturing processes corresponding to the inputs, and may determine at least one of a machine learning model or a simulation model corresponding to at least one manufacturing process related to the inputs. The computing device may input information related to a plurality of candidate materials into the machine learning model or simulation model to determine a predicted property of the respective candidate materials related to the performance parameter. In addition, the computing device may compare the predicted properties with each other to select at least one of a selected material or a selected manufacturing process, and may send, to the user device, information related to the selected material and/or selected manufacturing process.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a computer system able to determine an optimal material and/or process for manufacturing a product according to some implementations.

FIG. 2 illustrates an example process performed by the service computing device, such as by execution of the management program and the prediction program according to some implementations.

FIG. 3 illustrates example details of the prediction program, manufacturing database(s), and material database(s) according to some implementations.

FIGS. 4A-4B illustrate examples of property performance vs. input parameter(s) according to some implementations.

FIG. 5 illustrates an example user interface according to some implementations.

FIG. 6 illustrates an example of the user interface according to some implementations.

FIG. 7 illustrates an example of the user interface according to some implementations.

FIG. 8 illustrates an example data structure demonstrating an example technique for calculating scores for materials according to some implementations.

FIG. 9 illustrates an example graph demonstrating how a manufacturing process may affect material properties and evaluation results according to some implementations.

FIG. 10 illustrates an example process performed by the service computing device, such as by execution of the management program and the prediction program according to some implementations.

### DETAILED DESCRIPTION

Some implementations herein are directed to techniques and arrangements for automatically determining a material and/or manufacturing process that includes employing machine learning and/or computer simulation for determining an optimal material and/or optimal manufacturing process for producing a product. In some examples, a system may be configured to receive, over a network, input via a user interface presented on a user computing device. In addition, the system may access material supplier information and may apply one or more machine learning models or simulation models at least partially for determining material performance following specific manufacturing processes. Based at least on this information, the system may determine one or more optimal materials that conform to the user's design and the material supplier's specifications without requesting domain knowledge in materials or manufacturing processes.

The system may include a backend portion that includes a plurality of databases having information received from manufacturers, material suppliers, certified testing service providers, and so forth. In addition, the backend portion may include a prediction program that may employ established manufacturing predictive capabilities, process monitoring knowhow, and digitized production knowledge. Accordingly, the system is able to determine optimal materials and associated suppliers based on a specific manufacturing process, desired quality and/or desired performance requirements from the users (e.g., designers, manufactures, etc.). Additionally, or alternatively, the system may determine an optimal manufacturing process based on a specified material, desired quality and/or desired performance requirements.

The system herein may provide a user interface that enables users to systematically specify performance requirements, search optimal materials, and/or implement better process controls for achieving a desired product quality. The system may also enable exchange of information with selected material suppliers. With the advanced material/process determination function provided by the system herein, users are able to setup manufacturing process input parameters, and are able to specify performance property requirements for a product based on a specified manufacturing process(es) has been performed. In some cases, the system may select a plurality of materials and associated suppliers that satisfy the user requirements, and may return the results to the user, such as with one or more recommendations. Alternatively, in other cases, the system may apply the result directly to a manufacturing device, such as a 3D printer or Computer-Aided Manufacturing (CAM) machine, for producing a part using the selected optimal material and/or process.

In the case that the user does not provide the process input parameters, the system may generate and provide proposed optimal parameters to the user. In the backend portion of the system, in addition to certain algorithms that power the prediction program, a plurality of different databases, such as one or more materials databases and one or more manufacturing databases may be employed for training the machine learning models utilized by the prediction program herein. Other information collected through the user interface or through other sources may also be stored in one or more databases, such as a client database, a supplier database, and an inventory database. These additional databases may be used to provide further services such as inventory planning, analytics, and so forth.

Some examples herein provide an easy-to-use (no technical background in materials or manufacturing required) system to quickly provide users with an optimal material and/or manufacturing process to use for producing a product. The techniques herein reduce the processing required by first checking for one or more relevant machine learning models to use for the analysis. If a suitable machine learning model is available, the system may provide results in real time or near real time. If a suitable machine learning model is not available, the system may resort to using a simulation model to perform the analysis. After a sufficient amount of simulation data has been generated by the simulation model, a new machine learning model may be trained using at least in part the simulation data. Subsequently, the new machine learning model may be used for future requests instead of the simulation model, thereby reducing delay in providing results and reducing required processing capacity. Implementations herein may provide design engineers, manufacturers, and other users information on optimal materials for specific manufacturing processes for meeting a user's performance requirements for a product.

Some examples herein provide material and manufacturing knowledge based material selection and material processing information. The system herein is able to predict material and/or product properties, quality and performance after manufacturing is completed. Thus, the system provides a technical improvement by providing reliable optimization of material selection, and may be used for engineering material selection and optimization of manufacturing processes. The system herein enables quick and accurate prediction of material manufacturability and post-process product quality and performance based on the user's specified requirements.

Implementations herein provide improvements in manufacturing technology that include matching an optimal material/manufacturing process with a designed product or other article of manufacture to ensure that the quality of the article is consistent and predictable, while failures due to incorrect or substandard materials are minimized. Additionally, implementations herein may improve traceability of materials, shorten product development cycles, and reduce recalls of the manufactured products.

For discussion purposes, some example implementations are described in the environment of determining a material and/or process for manufacturing a product. However, implementations herein are not limited to the particular examples provided, and may be extended to other types of computing environments, other system architectures, other types of graphic elements in the user interface, other materials, other manufacturing processes, and so forth, as will be apparent to those of skill in the art in light of the disclosure herein.

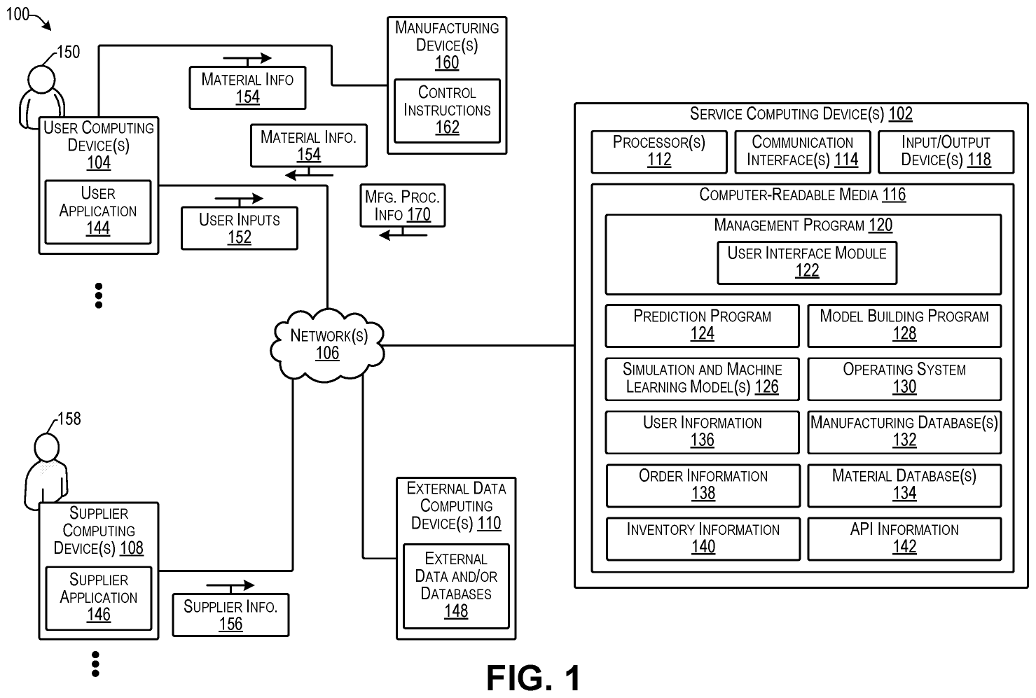

FIG. 1 illustrates an example architecture of a computer system 100 able to determine an optimal material and/or process for manufacturing a product according to some implementations. The system 100 includes one or more service computing devices 102 that are able to communicate with one or more user computing devices 104 over one or more networks 106. The service computing device(s) 102 may further communicate over the one or more networks 106 with one or more supplier computing devices 108 and one or more external data computing devices 110.

In some examples, the service computing device(s) 102 may include one or more servers, personal computers, embedded processors, or other types of computing devices that may be embodied in any number of ways. For instance, in the case of a server, the applications, programs, other functional components, and at least a portion of data storage may be implemented on at least one server, such as in a cluster of servers, a server farm or data center, a cloud-hosted computing service, and so forth, although other computer system architectures may additionally or alternatively be used.

In the illustrated example, the service computing device(s) 102 includes, or otherwise may have associated therewith, one or more processors 112, one or more communication interfaces 114, one or more computer-readable media 116, and one or more input/output (I/O) devices 118. Each processor 112 may be a single processing unit or a number of processing units, and may include single or multiple computing units, or multiple processing cores. The processor(s) 112 may be implemented as one or more central processing units, microprocessors, microcomputers, microcontrollers, digital signal processors, state machines, logic circuitries, and/or any devices that manipulate signals based on operational instructions. For instance, the processor(s) 112 may be one or more hardware processors and/or logic circuits of any suitable type specifically programmed or otherwise configured to execute the algorithms and other processes described herein. The processor(s) 112 may be configured to fetch and execute computer-readable instructions stored in the computer-readable media 116, which can configure the processor(s) 112 to perform the functions described herein.

The computer-readable media 116 may include volatile and nonvolatile memory and/or removable and non-removable media implemented in any type of technology for storage of information such as computer-readable instructions, data structures, program modules, or other data. For example, the computer-readable media 116 may include, but is not limited to, RAM, ROM, EEPROM, flash memory or other memory technology, optical storage, solid state storage, magnetic tape, magnetic disk storage, RAID storage systems, object storage systems, storage arrays, network attached storage, storage area networks, cloud storage, or any other medium that can be used to store the desired information and that can be accessed by a computing device. Depending on the configuration of the service computing device(s) 102, the computer-readable media 116 may be a tangible non-transitory medium to the extent that, when mentioned, non-transitory computer-readable media exclude media such as energy, carrier signals, electromagnetic waves, and/or signals per se. In some cases, the computer-readable media 116 may be at the same location as the service computing device(s) 102, while in other examples, the computer-readable media 116 may be partially remote from the service computing device(s) 102.

The computer-readable media 116 may be used to store any number of functional components that are executable by the processor(s) 112. In many implementations, these functional components comprise executable instructions and/or programs that are executable by the processor(s) 112 and that, when executed, specifically program the processor(s) 112 to perform the actions attributed herein to the service computing device(s) 102. Functional components stored in the computer-readable media 116 may include a management program 120, The management program 120 may include one or more computer programs, program modules, computer-readable instructions, executable code, or portions thereof that are executable to cause the processor(s) 112 to perform various tasks, such as for providing a user interface to the user computing device, communicating with various computing devices, and performing various functions attributed to the service computing device(s) 102. In the illustrated example, the management program 120 includes or may invoke a user interface module 122. For instance, the management program 120 may cause execution of the user interface module 122 to provide a user interface to the user computing device(s) 104. As one example, the user interface module 122 may include a web application, or the like, that may be executed using a browser on the user computing device(s) 104 to present a user interface on the user computing device(s) 104. Further, various other techniques for providing a user interface to the user computing device(s) will be apparent to those of skill in the art having the benefit of the disclosure herein.

Additional functional components stored in the computer-readable media 116 may include a prediction program 124 that may be invoked by the management program 120 to employ the simulation and machine-learning models 126 to determine an optimal material, manufacturing process, and/or other information based on inputs received from a user computing device via the user interface, or the like. In addition, a model building program 128 may be invoked to generate, train, and validate the machine learning model(s) of the simulation and machine-learning models 126. In some cases, the prediction program 124 and the model building program 128 may be executable modules, subroutines, or the like, of the management program 120. Alternatively, in other examples, some or all of the user interface module 122, the prediction program 124 and the model building program 128 may be separately executable stand-alone computer programs. Additionally, the functional components in the computer-readable media 116 may include an operating system 130 that may control and manage various functions of the service computing device(s) 102. In some cases, the functional components may be stored in a storage portion of the computer-readable media 116, loaded into a local memory portion of the computer-readable media 116, and executed by the one or more processors 112. Numerous other software and/or hardware configurations will be apparent to those of skill in the art having the benefit of the disclosure herein.

In addition, the computer-readable media 116 may store data and data structures used for performing the functions and services described herein. For example, the computer-readable media 116 may store the simulation and machine-learning models 126 that may be utilized by the prediction program 124, such as for determining optimal materials, optimal manufacturing processes, or the like. As discussed additionally below, examples of such simulation and machine-learning models 126 include predictive models, decision trees, classifiers, regression models, such as linear regression models, support vector machines, stochastic models, such as Markov models and hidden Markov models, artificial neural networks, such as recurrent neural networks, and so forth. Details of some example simulation and machine-learning models 126 are discussed additionally below.

In addition, the computer-readable media may store one or more manufacturing databases 132 and one or more material databases 134. Further, while the term “database” is used in the description herein as one example of information storage, the “databases” may include any type of data structure(s) able to store information. Additionally, the computer-readable media 116 may store user information 136, order information 138, and inventory information 140. For instance the user information 136 may include user account information as well as information provided about specific products, designs, etc., to be manufactured or the like. The order information 138 may include information obtained from supplier computing devices 108, such as material information (e.g., types, properties, ratings, certifications, etc.). Further, the inventory information may also include information obtained from supplier computing devices 108, such as to provide information regarding availability of selected materials offered by respective suppliers.

In addition, the computer-readable media 116 may store application programing interface (API) information 142. For example, the API information may include information enabling communications between the management program 120 and a user application 144 executing on the user computing device 104. In addition, the API information may include information enabling communication between the management program 120 and a supplier application 1146 executing on the supplier computing device 108 to enable the management program to receive material information and or manufacturing information from the suppliers or other sources. For example, the API information may enable the management program 120 to communicate with the external data computing device(s) 110, such as for accessing external data and/or databases 148 that may be provided by the external data computing device(s) 110. Examples of external data computing devices may include webservers, network computing devices, or the like that may provide access to independently maintained databases, such as government databases, standards organization databases, and so forth.

Furthermore, the service computing device 102 may also include or maintain other functional components and data not specifically shown in FIG. 1, which may include programs, drivers, etc., and the data used or generated by the functional components. Further, the service computing device 102 may include many other logical, programmatic, and physical components, of which those described above are merely examples that are related to the discussion herein.

The service computing device 102 may further be equipped with various input/output (I/O) devices 118. Such I/O devices 118 may include a display, various user interface controls (e.g., buttons, joystick, keyboard, mouse, touch screen, etc.), audio speakers, connection ports and so forth.

The communication interface(s) 114 may include one or more interfaces and hardware components for enabling communication with various other devices, such as over the one or more networks 106. Thus, the communication interfaces 114 may include, or may couple to, one or more ports that provide connection to the network(s) 106 for communicating with the user computing device(s) 104, the supplier computing device(s) 108, and the external data computing devices 110. For example, the communication interface(s) 114 may enable communication through one or more of a LAN (local area network), WAN (wide area network), the Internet, cable networks, cellular networks, wireless networks (e.g., Wi-Fi) and wired networks (e.g., fiber optic, Ethernet, Fibre Channel), direct connections, as well as close-range communications, such as BLUETOOTH®, and the like, as additionally enumerated below.

The one or more networks 106 may include any type of network, including a LAN, such as an intranet; a WAN, such as the Internet; a wireless network, such as a cellular network; a local wireless network, such as Wi-Fi; short-range wireless communications, such as BLUETOOTH®; a wired network including fiber optics, Ethernet, Fibre Channel, or any other such network, a direct wired connection, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the service computing device(s) 102, the client computing device(s) 108, other computing devices described below, and in some examples, the video sources 104, are able to communicate over the one or more networks 106 using wired or wireless connections, and combinations thereof.

In some implementations, suppose that a user 150 uses the user application 144 on the user computing device 104 to communicate with the management program 120 on the service computing device 102. For example, the user application 144 may be a web browser or other type of browser in some examples, or a proprietary application in other examples. In either event, the user application 144 may present a user interface (not shown in FIG. 1) to the user 150 to enable the user to provide user inputs 152 via the user interface. The management program 120 may receive the user inputs 152 and may invoke the prediction program 124 based on the user inputs 152 to determine material information 154, such as an optimal material to be used for manufacturing a component, part, or other product.

Further, the management program 120 may communicate with the supplier applications 146 on a plurality of the supplier computing devices 108 for obtaining supplier information 156 such as information about relevant materials available from the respective suppliers 158, including material specifications, material inventory, and the like. Additionally, or alternatively, the prediction program 124 may access the manufacturing database(s) 132 and the material database(s) 134, as well as inventory information 140 and/or the external data computing device 110 to obtain information relevant to the user inputs 152. Upon determining an optimal material, as well as material availability, material supplier, and the like, to be included in the material information 154, the management program 120 may send the material information 154 to the user computing device 104. In some cases, the material information 154 and/or the user inputs 152 may be encrypted when sent between the user computing device 104 and service computing device(s) 102.

Additionally, in some examples, the user computing device 104 may send the received material information 154 to a manufacturing device 160, such as a 3D printer or a CAD/CAM manufacturing device. For example, the user 150 may interact with control instructions 162 on the manufacturing device 160, may receive the material information 154, and may send the material information 154 to the manufacturing device 160 to produce the product based on the received material information 154. For instance, in the case of a 3D printer, the 3D printer may select the material to use based on the received material information 154 and may proceed to print the product. As another example, the service computing device 102 may be configured to communicate directly with the manufacturing device 160, such as for directly controlling the material used by the manufacturing device 160 manufacturing the product.

Additionally, or alternatively, the service computing device 102 may send manufacturing information 170 to the user computing device 104. For example, the manufacturing information may include information regarding an optimal manufacturing process for producing a product, a predicted assessment of quality, equipment selection for performing the manufacturing, and the like. Furthermore, while several example scenarios are described above with respect to FIG. 1, numerous other applications and variations will be apparent to those of skill in the art having the benefit of the disclosure herein.

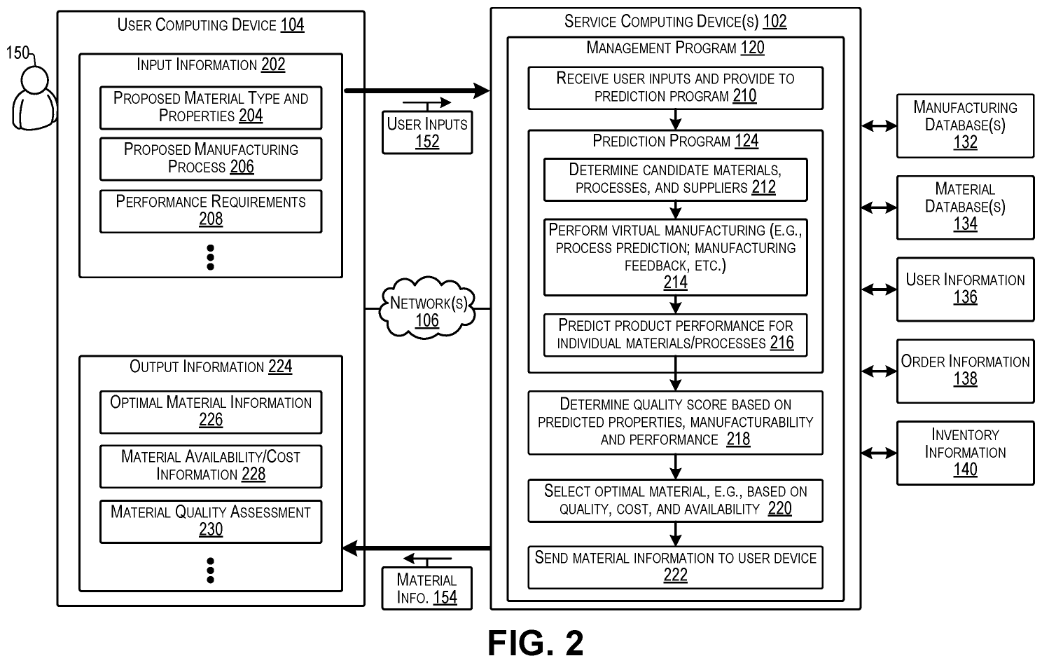

FIGS. 2, 3 and 10 include flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, systems, and devices described in the examples herein, although the processes may be implemented in a wide variety of other environments, systems, and devices.

FIG. 2 illustrates an example process performed by the service computing device 102, such as by execution of the management program 120 and the prediction program 124 according to some implementations. For instance, the service computing device 102 may provide a technical solution for providing material optimization and/or a manufacturing process optimization to a manufacturer, design engineer, other entity, or directly to a manufacturing device. Accordingly, the manufacturer, design engineer, or other user 150 may improve the manufacturing process for a product based on a current material already adopted or based on a new material.

In the illustrated example, the user 150 may initially determine input information 202, such as proposed material type and properties 204, proposed manufacturing process 206, performance requirements 208, and so forth. The user computing device may send the input information 202 to the service computing device(s) 102 as the user inputs 152, e.g., via the user interface discussed additionally below.

At 210, the management program 120 may receive the user inputs 152 and may provide the received user inputs 152 to the prediction program 124. For example, upon receipt of the user inputs 152, the management program 120 may invoke the prediction program 124 and may provide the user inputs 152 as inputs to the prediction program 124.

At 212, the prediction program 124 may receive the user inputs 152 and may search the manufacturing database(s) 132 and the material database(s) 134 to determine all candidate materials, processes, and suppliers corresponding to the user inputs received from the user. For instance, as discussed additionally below, the prediction program 124 may search for various candidate materials based on the proposed material types and properties 204, the performance requirements 208, and/or the proposed manufacturing process 206.

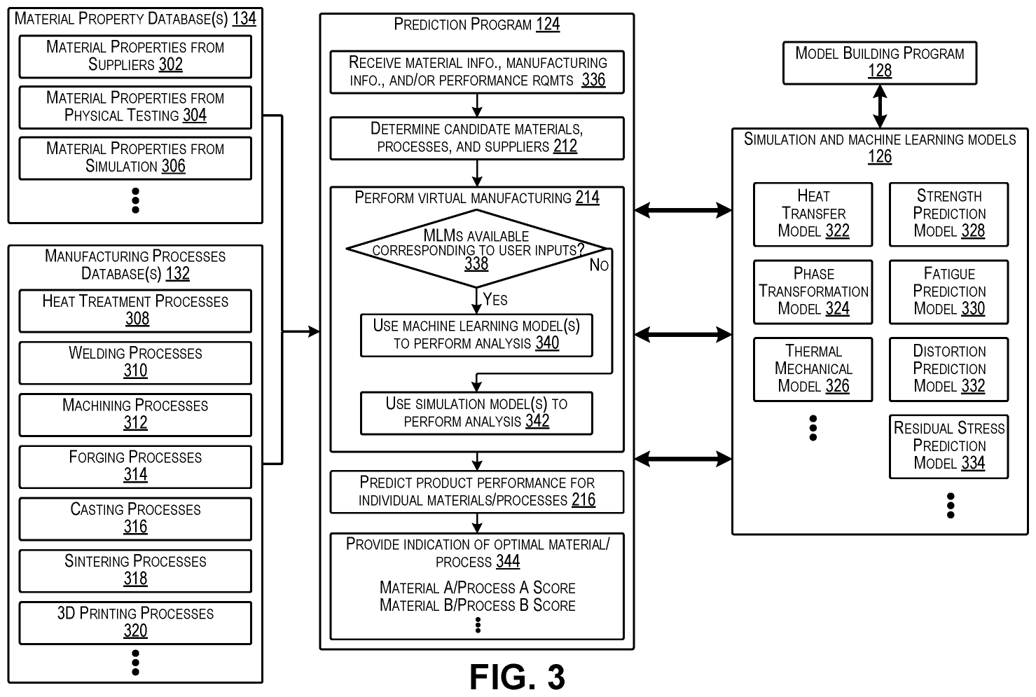

At 214, the prediction program 124 may perform virtual manufacturing such as process prediction, manufacturing feedback, and the like. As discussed additionally below, e.g., with respect to FIG. 3, the prediction program 124 may execute one or more machine learning models and/or simulation models for determining manufacturing results for individual candidate materials and manufacturing processes selected at 212.

At 216, the prediction program 124 may predict product performance for individual candidate material and/or processes. For example, as discussed below, the prediction program my receive the results of the one or more machine learning models and/or simulation models and may predict performance parameters for a candidate material/process, such as strength, hardness, ductility, toughness, elasticity, and so forth. In some cases, the prediction program may also access the manufacturing database(s) 132 and/or the material database(s) 134 during this operation.

At 218, the management program 120 may determine a quality score based on the predicted properties. For example, the quality score may be determined based on a combination of the predicted properties, predicted manufacturability, and predicted performance. In some cases weighting factors may be applied when determining the quality score, such as based on the user inputs 152 emphasizing one or more material properties, performance, or the like.

At 220, the management program 120 may select one or more optimal materials, e.g., based on determining an overall or total score for each candidate material, such as based on the quality score determined at 218, the cost of the material, and the availability of the material (e.g., the availability of the material to be provided to the user in a manner sufficiently timely). During the selection, the management program may take into consideration the user information 136, the order information 138, and inventory information 140, such as for determining deliverability of the material to the user location, availability of the material from suppliers, costs of the materials, and the like.

At 222, the management program 120 may send information about one or more selected materials to the user computing device as the material information 154. For example, if there are several materials with similar total scores (e.g., within a few percentage points of each other), the management program 120 may send a list of several optimal materials, and may also include the score for each of the materials.

The user computing device 104 may receive the material information 154 from the service computing device 102 as output information 224. As mentioned above, in some examples, the output information 224 may be presented to the user 150. In other examples, the material information 154 may be directly applied to a manufacturing device (not shown in FIG. 2). Accordingly, after processing the user inputs 152 received from the user computing device 104, the management program 120 in cooperation with the prediction program 124 on the service computing device(s) 102 is able to generate optimal material information 226, determine material availability and cost information 228, perform a material quality assessment 230 for the materials, and so forth. The user 150 can quickly receive optimal material information 226 based on a specification of final product quality and performance.

FIG. 3 illustrates example details of the prediction program 124, manufacturing database(s) 132, and material database(s) 134 according to some implementations. For example, raw material properties and manufacturing process information and parameters may be employed to perform process and/or product quality and performance simulations. In this example, the material database(s) 134 may include material properties from suppliers 302, material properties from physical testing 304, and material properties from simulation 306. For instance, the material properties from suppliers 302 may include any current certifications (e.g., ASTM Intl., Japanese Industrial Standards Committee (JISC), American National Standards Institute (ANSI), Society of Automotive Engineers (SAE), MIL-SPEC, and so forth) provided by suppliers. Several examples of common material properties with respect to metals may include yield strength, Young's modulus, Poisson's ratio, and so forth. Properties from physical testing 304 may be determined following a specified requirement that is defined by or for the tester, and may be used for determining/specifying some uncommon material properties, such as anneal temperature, thermal expansion, and so forth. Material properties from simulation 306 may include some properties that are difficult to measure by testing, such as a stress/strain curve at elevated temperature, thermal properties for powders during a sintering process, and the like. In this case, the tester may apply certain material simulation programs to predict this type of material properties.

The manufacturing database(s) 132 may store information about a variety of manufacturing-process-related information, which may be used by the model building program 128 to establish a machine learning algorithm and train a corresponding machine learning model of the simulation and machine-learning models 126. Examples of manufacturing processes for which information may be included in the manufacturing database(s) 132 may include a heat treatment processes 308, welding processes 310, machining processes 312, forging processes 314, casting processes 316, sintering processes 318, and 3D printing processes 320. Furthermore, while several example material property types and manufacturing process types are described herein, numerous other examples and variations will be apparent to those of skill in the art having the benefit of the disclosure herein.

As mentioned above, the prediction program 124 may access a plurality of simulation and machine learning models 126, which may link and use supplier information, user inputs, the manufacturing database(s) 132, and the material database(s) 134 to generate predictions for the optimal materials and/or manufacturing processes. This may be a comprehensive and complex computation process that may include utilization of several models to perform certain types of information.

In the illustrated example, the simulation and machine-learning models 126 include a heat transfer model 322, a phase transformation model 324, a thermal mechanical model 326, a strength prediction model 328, a fatigue prediction model 330, a distortion prediction model 332, and a residual stress prediction module 334. Furthermore, while several example types of models are illustrated in this example, numerous other types of models will be apparent to those of skill in the art having the benefit of the disclosure herein, depending on the types of material and/or processes to be determined by the prediction program 124.

In some examples, the prediction program 124 may perform analysis using two different techniques, e.g., (1) prediction based on computer simulation and (2) prediction based on artificial intelligence (AI) or other machine learning. For example, the heat transfer model 322, the phase transformation model 324, the thermal mechanical model 326, and the like, may be computer simulation models. These models 322-326 may be manufacturing process simulation models that are configured to provide predicted results even if there is no corresponding manufacturing process information in the manufacturing database 132. Other models 126, such as the strength prediction model 328, the fatigue prediction model 330, the distortion prediction model 332, the residual stress prediction model 334, and the like, may be machine learning models. For example, the machine learning models may be trained to predict results based on using information from the manufacturing database(s) 132 as training data for training the machine learning models 328-334. In some cases, the simulation models may be commercially available computer simulation models, while the machine learning models may be generated and trained by the model building program 128 using the manufacturing database(s) 132 and the material database(s) 134.

As one example, the heat transfer model 322 may be a simulation model used to analyze heat transfer in any manufacturing processes related to heat, for example, heat treatment, welding, forging, casting sintering, etc. The input information may include a comprehensive series of thermal features, such as initial temperature difference between the engineering parts and the environment, external heat source, heat transfer types, and material properties. The output may include a temperature profile, historical temperature data, and the like.

As another example, the phase transformation model 324 may be a simulation model used to analyze phase transformations during any thermal process, such as welding, casting, heat treatment, and so forth. The input may include all the information required in the heat transfer analysis as well as material chemical compositions. The output may include a phase distribution for the material.

As another example, the thermal mechanical model 326 may be a simulation model, such as a multi-physics model including at least two different steps, one of which may be thermal analysis, such as through use of the heat transfer model 322 or the phase transformation model 324, the other of which may be a mechanical analysis, such as strength analysis of the material. Accordingly, the thermal mechanical model 326 may predict the strength of a part after a thermal process. The input may include information obtained from the heat transfer model 322 and/or the phase transformation model 324, as well as material mechanical properties, external mechanical loading conditions, and the like. The output of the thermal mechanical model may include a residual stress, yield strength, fatigue life, hardness of the part, and so forth.

As another example, the strength prediction model 328, the fatigue prediction model 330, the distortion prediction model 332, and the residual stress prediction model 334 may be trained machine learning models that have been trained using information in the manufacturing database(s) 132 and the material database(s) 134. For example, for the strength prediction model 328, input may include receiving information from previous customer records, testing records, certificates, internal performance records, and the like, for the same material after same process treatment or the like. The model output may be the strength of the material/part after the selected manufacturing process has been performed.

Furthermore, it may be noted that there can be some overlap between the simulation models 322-326 and the machine learning models 328-334. However, these models have different applications in some cases. For example, when the prediction program 124 receives a request from a user, the prediction program 124 may first determine whether the machine learning models (e.g., models 328-334 in this example, or additional models in other examples) are available to model the input process, material, and performance requirements. If so, the output may be based on utilizing the machine learning models, and the solution may be determined quickly, e.g., in real time or near real time. However, if the machine learning models are not configured for receiving the user inputs, then the prediction program 124 may instead execute one or more of the simulation models (e.g., models 322-324 in this example or various other simulation models in other examples). As is known in the art, executing a simulation model may take considerable computing power and time in some cases. Accordingly, the prediction program 124 may take some time to provide the results. However, the results may be stored in the manufacturing database(s) 132, and when sufficient results of the same type have been stored, a new machine learning model may be generated based on the results of the simulation processing. Accordingly, over time the number and variety of the machine learning models may be increased, thereby reducing the use to use the simulation models.

As discussed above with respect to FIG. 2, the prediction program 124 may be invoked by the management program following receipt of user inputs from a user computing device or the like.

At 336, the prediction program 124 may receive material information, manufacturing information and/or performance requirements from the management program (not shown in FIG. 3) which are based on the user inputs received by the management program, such as in 210 mentioned above.

At 212, as mentioned above, the prediction program 124 may search the manufacturing database(s) 132 and the material database(s) 134 to determine all candidate materials, processes, and suppliers corresponding to the inputs received from the user.

At 214, the prediction program 124 may perform virtual manufacturing such as process prediction, manufacturing feedback, and the like. For example, the system may establish the relationships between the input information for material and manufacturing process, and the specified performance requirements, such as in comparison to final performance properties of a particular material after a particular manufacturing process. For instance, the prediction program 124 may access the corresponding manufacturing database 132 to locate the specific manufacturing process and employ corresponding prediction models 126 as discussed below at 338-342.

At 338, the predication program 124 may determine whether there are one or more machine learning models (MLMs) that correspond to the user inputs. As mentioned above, the prediction program 124 may give priority to performing analysis using the machine learning models rather than the simulation models, which may enable the prediction program 124 to provide results in real time or near real time. However if the prediction program 124 is not able to locate necessary information related to the inputs in the manufacturing database 132 and locate corresponding machine learning models, the prediction program 124 may employ one or more of the simulation models instead. The benefits of doing this is to enable the prediction program 124 to provide prediction for a wide range of materials and manufacturing processes even if no existing data related to a particular manufacturing process is in the manufacturing database 132.

At 340, if the prediction program 124 locates machine learning models corresponding to the user inputs, the prediction program 124 may provide the inputs to the machine learning models and employ the machine learning models to determine material properties from corresponding manufacturing processes.

At 342, alternatively, if the prediction program 124 locates machine learning models corresponding to the user inputs, the prediction program 124 may execute one or more simulation models for determining material properties from corresponding manufacturing processes.

Accordingly, after the user indicates a proposed manufacturing process, process parameters that the user wants to apply (which may be not mandatory), and indicates the final properties that the user would like to the final product to have, the prediction program 338 may perform analysis on a plurality of candidate materials and/or alternative candidate processes using the models 126.

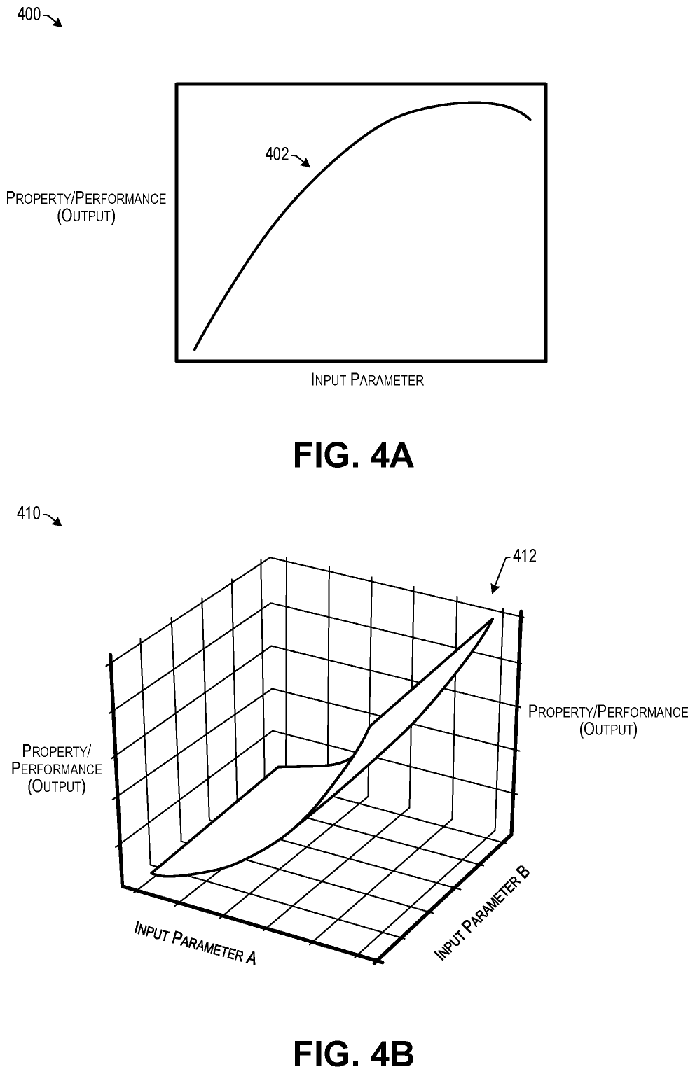

As one example, the inputs to the models 126 may include manufacturing process parameters from the user, if provided, process specifications (e.g., machine information, environment information, and the like.). The output of the models 126 may include the final predicted properties based on the properties that the user may have specified. For a specific manufacturing process or a specific model 126, the number of input parameters may be different. For example, as discussed below with respect to FIGS. 4A-4B, the relation between the input parameters and the output performance may be one-dimensional, two-dimensional, or multi-dimensional.

At 216, as discussed above, the prediction program 124 may compare the predicted performance properties with the user requirements. If the user provides process parameters, the prediction program 124 may determine the properties according to the user inputs. On the other hand, if the user input parameters are not applicable, the prediction program 124 may determine optimal properties as well as the optimal manufacturing process parameters.

At 344, the prediction program 124 may provide a listing of one or more optimal materials and/or processes. For example, if all user performance requirements are met, the material may be selected as a candidate optimal material. In some cases, the prediction program 124 may further provide material details, supplier information, and the like. Alternatively, in other examples, as discussed above with respect to FIG. 2, the management program may determine this information along with determining a total score for each material/process as discussed above.

FIGS. 4A-4B illustrate examples of property performance vs. input parameter(s) according to some implementations. As mentioned above, for a specific manufacturing process or a specific model, the number of input parameters may be different. For example, as illustrated in FIGS. 4A-4B, the relation between the input parameters and the output property or performance may be one-dimensional, two-dimensional, or multi-dimensional.

As illustrated at FIG. 4A, a graph 400 shows a one-dimensional relationship between an input parameter and a property or performance (e.g., an output of a model). For instance, a curve 402 may represent the one-dimensional relationship, in which a single input to a model results in a single property or performance parameter output. For example, as discussed above with respect to FIG. 3, an optimized property/performance may be determined based on the relationship between the input parameter and the output property/performance indicated by the graph 400.

As illustrated at FIG. 4B, in other examples, there may be a multi-dimensional relationship between the property/performance (outputs) and multiple input parameters. For instance, a graph 410 includes an input parameter A and an input parameter B, and a multi-dimensional shape 412 represents the corresponding property or performance parameter output of a model. For example, as discussed above with respect to FIG. 3, optimized properties/performances may be determined based on the relationship between the input parameters and the output properties/performances indicated by the graph 410.

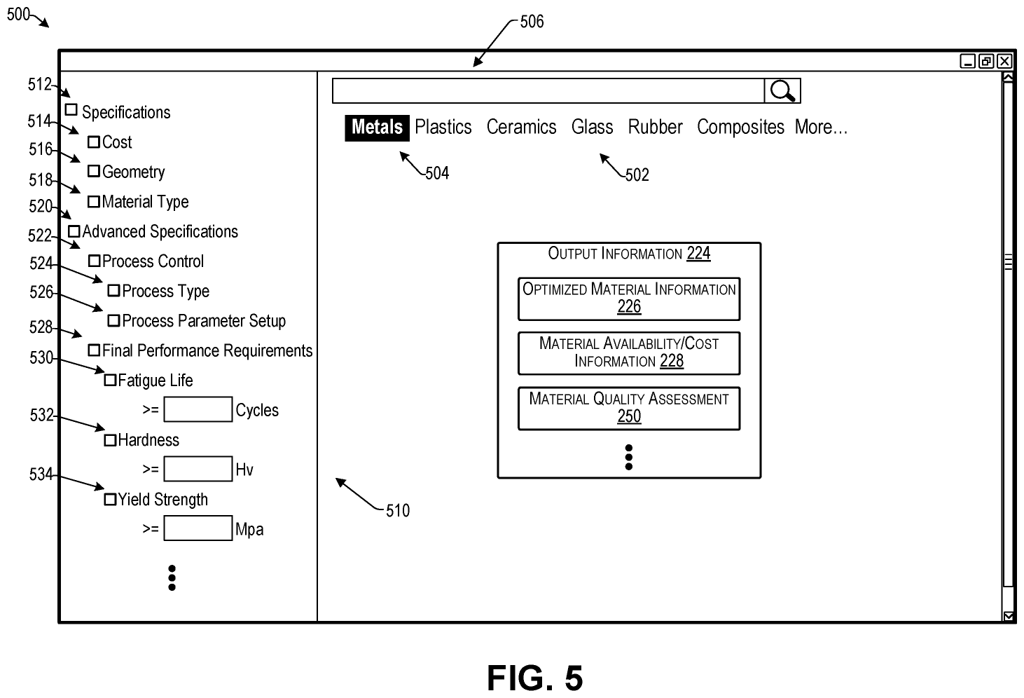

FIG. 5 illustrates an example user interface 500 according to some implementations. For example, the user interface 500 may be presented on a display associated with the user computing device 104 (not shown in FIG. 5) to enable a user to enter desired user inputs for determining optimal materials/processes for a product. In this example, the user interface 500 may include a listing 502 of different types of materials for which the user interface 500 may be used for selection, such as metals, plastics, ceramics, glass, rubber, composites, and more. In this example, suppose that metals is selected, as indicated at 504. In addition, the user interface 500 includes a search window 506 to enable the user to search for specific materials or suppliers.

Upon selection of metals, as indicated at 504, a sidebar 510 may be modified to present a plurality of selectable material properties and manufacturing processes. The sidebar 510 includes a selectable specifications 512, such as cost 114 geometry 516 and material type 518. In addition, the sidebar includes advanced specifications 520 such as process control 522, which may include process type 524, and process parameters set up 526; and final performance requirements 528, which may include fatigue life 530, hardness 532, and a yield strength 534.

Accordingly, the user interface 500 enables the user to specify material properties such as cost, geometry, material type, and the like, as well as specifying more advanced properties such as manufacturing process and performance requirements for the product. With the advanced specification function, user can specify manufacturing process type information, such as casting, welding, machining, forging, etc., as well as specifying process set up parameters. In addition, the user can specify final performance requirements for the product after the desired manufacturing process has been performed. For example, the user can specify a minimum number of fatigue cycles to failure, a minimum hardness, a minimum strength requirement, and so forth. Based on all these specified input information from user, the management program may receive the inputs via the user interface, invoke the prediction program 124, and may provide solutions (e.g., optimal materials and/or processes) to user interface 500 as the output information 224.

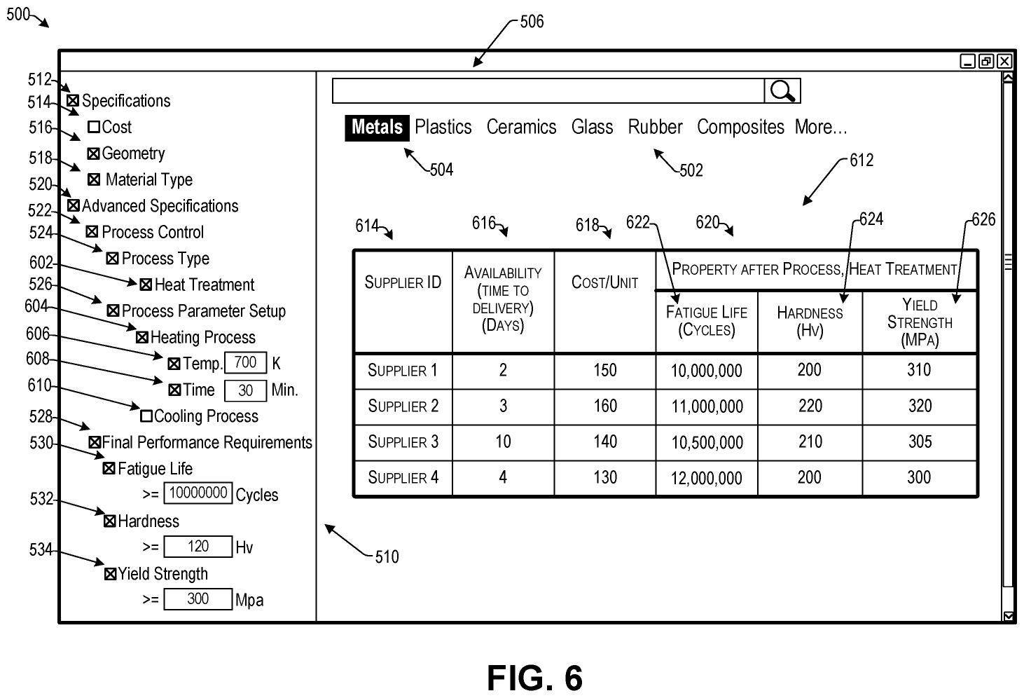

FIG. 6 illustrates an example of the user interface 500 according to some implementations. In this example, suppose that a manufacturer has designed a product and wants to determine a type of metal for manufacturing the product such as by improving the performance of the material by a heat treatment process, while ensuring that certain final performance requirements 528 are met. The user may launch the user interface 500 on the user computing device. As mentioned above, in some examples the user interface 500 may be provided by a web application running on a browser on the user computing device, may be a web page, or may be provided by a separate application executing on the user computing device, or may be provided by any of various other techniques. The user interface 500 may employ one or more APIs to communicate with the management program on the service computing device(s) and vice versa.

The user may interact with the user interface 500 to input specifications 512 and advanced specifications 520. For example, the user may specify a material type at 518 and a material geometry 516. Typically a user will desire to obtain a quick determination of an optimal material from the service computing device through the advanced specification function. As mentioned above, if the prediction program is able to use machine learning models for making the determination, the result may be returned quickly, e.g., in real time or near real time. Alternatively, if the prediction program runs one or more simulation models, the result may take some time to determine, and the user interface may present an estimate of when the results will be ready, such as based on an average time for the simulation model(s) to execute in the past.

In this example, suppose that the user specifies heat treatment as the process type at 602, and further specifies process parameters under process parameter setup 526. The process parameters for the heating process 604 include temperature 606, which is specified by the user to be 700 K, and process time 608, which is specified by the user to be 30 mins. A cooling process 610 is not specified at this point. In addition, the user further specifies that after the heat treatment process, the material should meet the following final performance requirements 528, i.e., fatigue life 530 should be greater than or equal to 10000000 cycles under a reverse bending fatigue with defined loading condition, a hardness 532 of the material should be greater than or equal to 120 Hv, and a yield strength 534 of the material should be greater than or equal to 300 MPa.

The information specified in the user interface 500 may be sent to the service computing device as user inputs 152 discussed above, an may be processed by the prediction program 124 as discussed above with respect to FIGS. 1-3. For example, the prediction program 124 may employ one or more corresponding machine learning models for performing the analysis. In this example, suppose that the prediction program uses the strength prediction model and the fatigue prediction model. The prediction program may complete the analysis, and the management program may cause the results 612 to be presented in the user interface 500.

In this example, the results 612 are presented in a data structure, such as a table, that includes a supplier identifier (ID) 614, an availability 616 (e.g., time required for delivery in days), a cost per unit 618, and predicted properties 620 after process, heat treatment. For example, the predicted properties may correspond to the final performance requirements specified by the user in the sidebar 510, including fatigue life 622, hardness 624, and yield strength 626. Based on the user specified input parameters, the system has identified materials from four different suppliers that are predicted to satisfying the requirements specified by the user. If the user wants to change the final performance requirements, the user may do so, and may be presented with different output results 612 in real time or near real time.

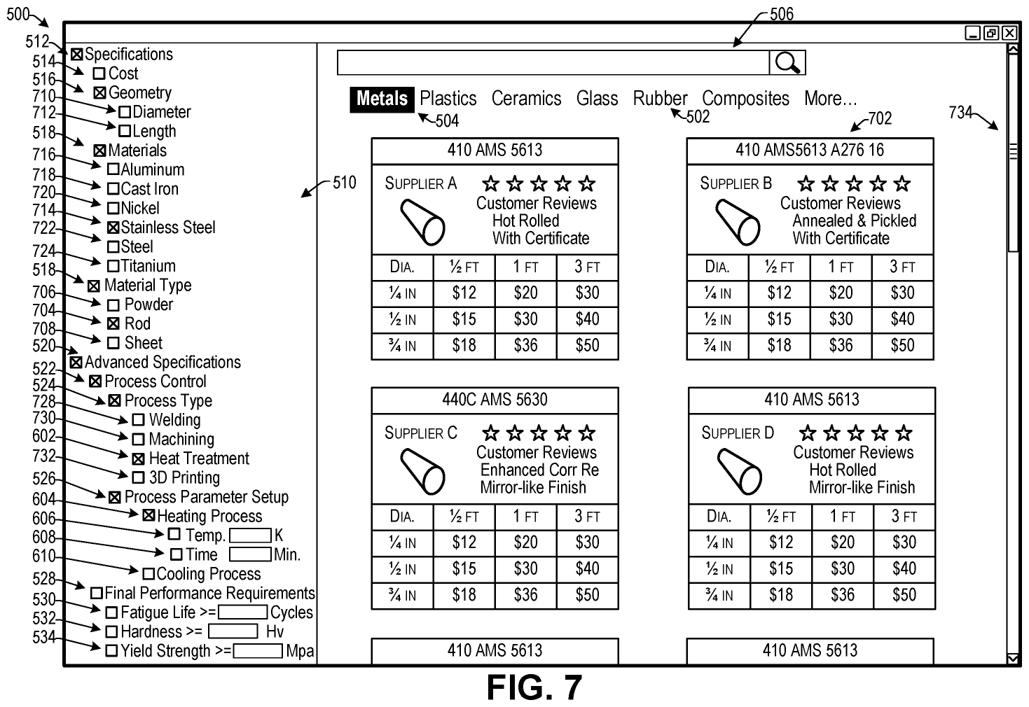

FIG. 7 illustrates an example of the user interface 500 according to some implementations. In this example, the results may be continually updated in the user interface 500, such as by providing more specific results as the user enters additional information into the sidebar 510. For instance, suppose in this example that the user has selected rod at 704 as material type 518, with other options being powder 706 and sheet 708. Further, the user has not yet specified a geometry 516 for the rod, such as diameter 710 and length 712, so a variety of geometries may be presented in the results 702. In addition, suppose that the user has selected stainless steel at 714, with other options being aluminum 716, cast iron 718, nickel 720, steel 722, and titanium 724.

Additionally, in this example, the user has selected heat treatment 602 as a process type, with other options being welding 728, machining 730, 3D printing 732. For example, upon selection of stainless steel at 714, the sidebar 510 may be updated to include process types that can be used with stainless steel and the specified material type. In addition, suppose in this example, the user has selected heat treatment but has not yet specified the temperature 606 and time 608 parameters for the heating process 604. Nor has the user yet specified the final performance requirements 528. Accordingly, the results at this point may generally be presented as a plurality of suppliers of stainless steel rod that is able to be heat treated. The user may use a scrollbar 734 to scroll down to view additional results. As the user enters more information and/or makes more selections in the user interface 500, the results 702 may become more specific, such as those illustrated in FIG. 6 or the like. Accordingly, the results may be continually and automatically updated by the management program as the user provides or selects additional information.

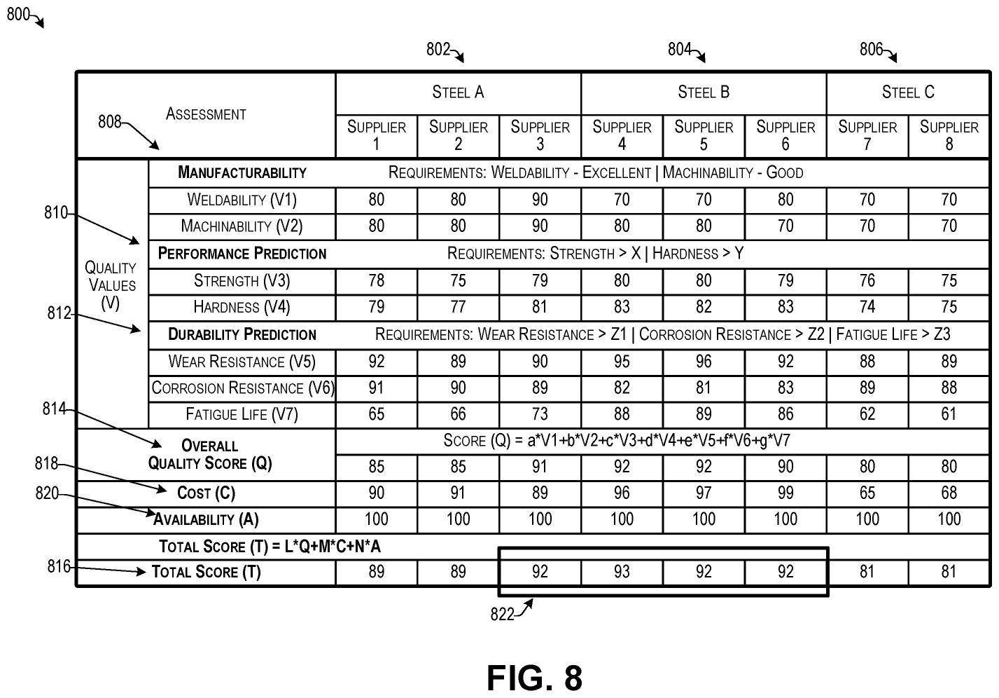

FIG. 8 illustrates an example data structure 800 demonstrating an example technique for calculating scores for materials according to some implementations. For instance, the prediction program and the management program may perform portions of the technique of FIG. 8. In this example, suppose the criteria specified by the user results in a selection of three candidate types of steels from eight candidate suppliers. Further, suppose that the manufacturing processes specified by the user include machining, assembling and welding. In this case, the user needs a material with best combination in three main indexes of quality, cost and delivery. Since quality is a complex index with multiple requirements specified by user, quality in this example may be determined using a weighted sum function of multiple sub-indexes.

Suppose that under the advanced specifications 520 in the user interface 500 discussed above, e.g., with respect to FIG. 7, that the user selects welding 728 and machining 730, rather than heat treatment 602. In this case, as a result of the selections, the user may be presented with weldability and machinability options as process parameter setups. For instance, suppose that the user specifies “excellent” as a weldability requirement and “good” as a machinability requirement. In addition, in the final performance requirements 528, suppose that the user specifies strength greater than value X and hardness greater than value Y. Furthermore, in the final performance requirements 528, suppose that the user also has the option to specify durability requirements, such as wear resistance greater than value Z1 and corrosion resistance greater than value Z2, in addition to specifying fatigue life greater than value Z3.

The user may submit the information entered into the user interface as the user inputs submitted to the service computing device(s) as discussed above. The management program may invoke the prediction program and input the user inputs to the prediction program. As discussed above with respect to FIGS. 2 and 3, the prediction program may perform analysis using the received user inputs as inputs to one or more machine learning models, or if appropriate machine learning models are not available, to one or more simulation models. In this example, suppose that machine learning models are available that correspond to the specified manufacturing processes. Accordingly, the results in the data structure 800 may represent outputs of the respective machine learning models for respective materials available from respective suppliers 1-8 and for respective candidate materials, namely steel A, as indicated at 802, steel B, as indicated at 804, and steel C, as indicated at 806. Furthermore, suppose that the outputs of the machine learning models represented in the data structure 800 are normalized to have a quality score on a scale between 1 and 100.

The data structure 800 indicates the predicted quality value V for each parameter, including manufacturability as indicated at 808 which includes weldability V1 and machinability V2. In addition, performance prediction 810 includes strength V3 and hardness V4, while durability prediction 812 includes wear resistance V5, corrosion resistance V6, and fatigue resistance V7. A corresponding quality value determined by the prediction program for each of these parameters is listed for the respective material 802-806 and supplier 1-8. For example, the weldability of steel A 802 offered by supplier 1 is predicted to have a weldability quality value V1 of 80, while the weldability of the steel B 804 offered by supplier 4 is predicted to have a weldability quality value V1 of 70 by the machine learning model used for predicting the weldability. The values V1-V7 for each parameter may be multiplied by a weighting factor (e.g., weighting factors a-g, respectively), and the products added together to obtain an overall quality score Q, i.e., Quality Score Q=a*V1+b*V2+c*V3+d*V4+e*V5+f*V6+g*V7. The resulting quality scores Q may be normalized on a scale of 1 to 100. In some examples, the weighting factors a-g may be specified by the user, by default, or in other cases, weighting factors a-g might not be used.

In addition, as indicated at 816, a total score T for each material from each supplier 1-8 may be determined by taking into consideration cost C, as indicated at 818 and availability A, as indicated at 820. For example, the total score T may be calculated by adding the scores of each main index (quality Q, cost C, and availability A) each multiplied with a respective weighting factor (L-N), i.e., total score T=L*Q+M*C+N*A. The total score T may be normalized to a scale of 1-100 and may be used as a criterion to evaluate the overall optimal value of each material for the intended use in the proposed product. As indicated at 822, by setting the optimal grade with a total score above 90, steel A from supplier 3 and steel B from suppliers 4-6 are determined as optimal materials for the user to for manufacturing of the proposed product. As one non-limiting example, an optimal material may include a lowest or lower cost material that is able meet all design performance parameters and that can meet delivery or other availability requirements. Further, while the criteria discussed above provide one example for determining an optimized material, numerous variations will be apparent to those of skill in the art having the benefit of the disclosure herein.

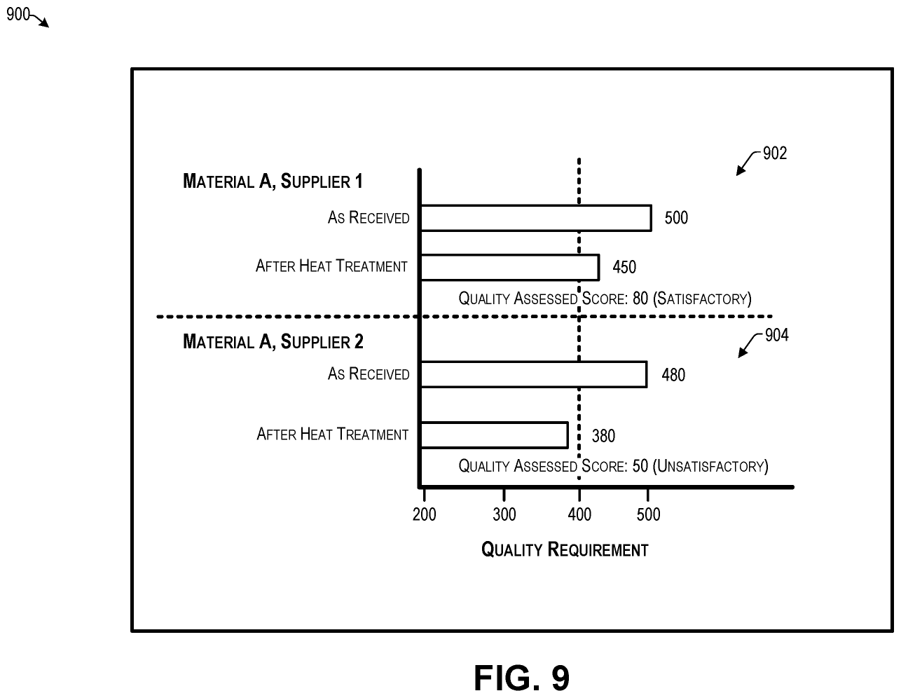

FIG. 9 illustrates an example graph 900 demonstrating how a manufacturing process may affect material properties and evaluation results according to some implementations. In this example, as indicated at 902, a predicted quality score for material A supplied by supplier 1 is represented for a particular quality requirement. A similar predicted quality score for material a supply by supplier to is indicated at 904. Accordingly, the same grade material A, there are two materials suppliers (supplier 1 and supplier 2) to be evaluated.

Suppose that in this example, the manufacturing process only includes a heat treatment operation, and that the material A should have a quality requirement (e.g., a hardness) higher than 400 units after the heat treatment process is completed. The raw materials A from both suppliers (as received) have a similar quality that is well above the quality requirement before the manufacturing process is performed, i.e., 500 for supplier 1 and 480 for supplier 2. However, after the heat treatment process is performed, only material A from supplier 1 satisfies the quality requirement, e.g., with a predicted assess quality score of 80. On the other hand, the material A from supplier 2 fails to meet the quality requirement with an assessed quality score of 50 based on a predicted hardness of 380. Accordingly, based on the knowledge of the post-process quality, the user may make an accurate determination to use material A from supplier 1 during the manufacturing process and thereby improving the quality of the product produced by the manufacturing process.

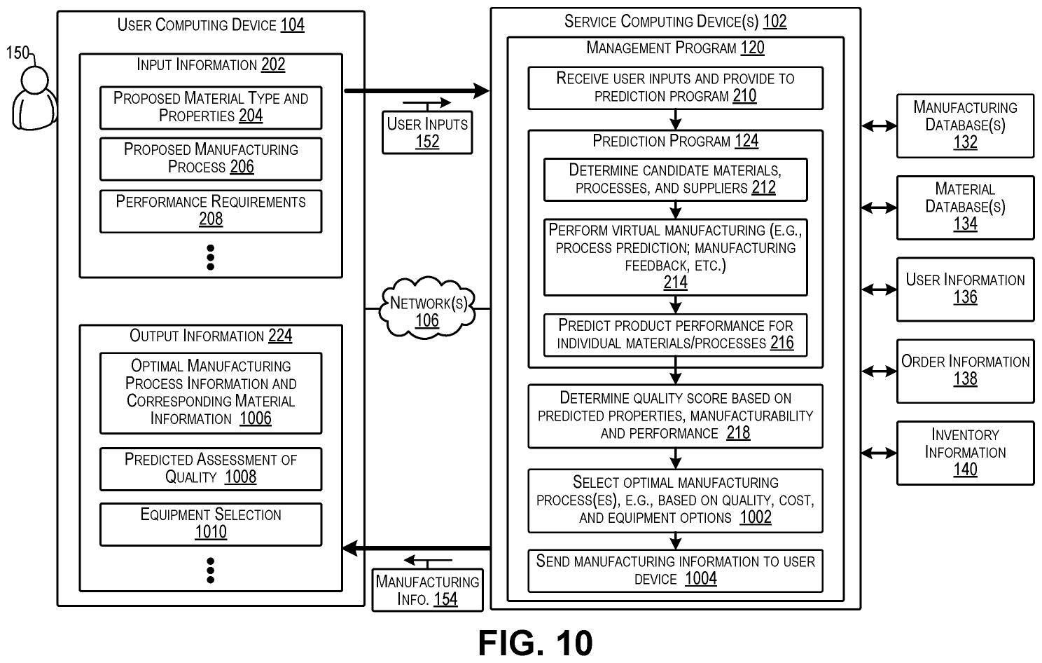

FIG. 10 illustrates an example process performed by the service computing device 102, such as by execution of the management program 120 and the prediction program 124 according to some implementations. For instance, similar to FIG. 2 above the service computing device 102 may provide a technical solution for providing material optimization and/or a manufacturing process optimization to a manufacturer, design engineer, other entity, or directly to a manufacturing device. Accordingly, the manufacturer, design engineer, or other user 150 may improve the manufacturing process for a product based on a current material already adopted or based on a new material.

In the illustrated example, the system may provide information for manufacturing process optimization in addition to or in alternative to providing optimal material information. For instance, the system may determine an improved or otherwise more optimal manufacturing process for the user based on the user's current proposed material type and properties 204, as well as the user's performance requirements 208. In this example, the user inputs 152 are provided to the service computing device(s) 102 as discussed above, but suppose that the user does not provide a proposed manufacturing process 206, or that the proposed manufacturing process 206 is not able to achieve the specified performance requirements 208 with the proposed material.

In this case, blocks 210-218 may be performed as discussed above with respect to FIG. 2. After processing the user inputs 152 received from the user computing device 104, the prediction program 124 may generate optimal manufacturing process options, which may include an assessment of quality improvement and cost for the provided manufacturing process options, equipment options, and the like.

At 1002, based on the output of the prediction program 124, the management program 120 may select optimal manufacturing process(es), e.g., based on quality, cost, and equipment options. For example, as discussed above with respect to FIG. 8, the management program may determine a total score for various candidate manufacturing processes, which may also take into consideration costs of manufacturing, and costs and availability of a corresponding material to be used in the manufacturing process.

At 1004, the management program may send the determined optimal manufacturing information to the user device 104.

The user computing device 104 may receive the manufacturing information 154 as the output information 224, which in this example includes optimal manufacturing process information and corresponding material information 1006, predicted assessment of quality 1008, equipment selection 1010 for performing the manufacturing process, and so forth. Accordingly, through the process in FIG. 10, the user can quickly receive information for executing an optimal manufacturing process using a specified material for producing a product meeting specified performance requirements.

The example processes described herein are only examples of processes provided for discussion purposes. Numerous other variations will be apparent to those of skill in the art in light of the disclosure herein. Additionally, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

Various instructions, methods, and techniques described herein may be considered in the general context of computer-executable instructions, such as computer programs and applications stored on computer-readable media, and executed by the processor(s) herein. Generally, the terms program and application may be used interchangeably, and may include instructions, routines, modules, objects, components, data structures, executable code, etc., for performing particular tasks or implementing particular data types. These programs, applications, and the like, may be executed as native code or may be downloaded and executed, such as in a virtual machine or other just-in-time compilation execution environment. Typically, the functionality of the programs and applications may be combined or distributed as desired in various implementations. An implementation of these programs, applications, and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed:

1. A system comprising:
one or more processors; and
one or more non-transitory computer-readable media maintaining executable instructions, which, when executed by the one or more processors, configure the one or more processors to perform operations comprising:
receiving, by the one or more processors, from a computing device, via a user interface, a proposed material, a proposed manufacturing process and at least one performance parameter;
determining at least one of a machine learning model or a simulation model related to the proposed manufacturing process;
determining a plurality of candidate materials based on at least one of the proposed material, the proposed manufacturing process, or the at least one performance parameter;
providing, as input to the at least one machine learning model or simulation model, information related to the plurality of candidate materials;
determining, based at least partially on outputs of the at least one machine learning model or simulation model, at least one of an optimal material or an optimal manufacturing process; and
sending, to the computing device, information related to at least one of the optimal material or the optimal manufacturing process.

2. The system as recited in claim 1, the operation of determining the at least one of the machine learning model or the simulation model related to the proposed manufacturing process comprising:
based on determining that a machine learning model related to the proposed manufacturing process is available, providing the input to the machine learning model; or
based on determining that a machine learning model related to the proposed manufacturing process is not available, providing the input to the simulation model.

3. The system as recited in claim 2, based on the machine learning model being not available, the operations further comprising:
following providing the input to the simulation model, storing an output of the simulation model to a manufacturing database; and
training a new machine learning model related to the proposed manufacturing process based at least partially on the output of the simulation model.

4. The system as recited in claim 1, the operation of determining a plurality of candidate materials further comprising searching at least one of a materials database or a manufacturing database to determine the plurality of candidate materials.

5. The system as recited in claim 1, the operation of determining, based at least partially on the outputs of the at least one machine learning model or simulation model, at least one of an optimal material or an optimal manufacturing process further comprising:
determining, based on the outputs, a quality value for each candidate material based on a prediction of the candidate material meeting the performance parameter; and
determining the optimal material based at least partially on determining the candidate material predicted to meet the performance parameter.

6. The system as recited in claim 1, wherein there are a plurality of the performance parameters received from the computing device, the operations further comprising:
determining, based on the outputs, a respective quality value for each candidate material for each performance parameter respectively, based on a prediction of the candidate material meeting the respective performance parameter;
applying a weighting factor to at least one quality value;
combining the quality values for each candidate material with the weighting factor applied to determine a respective quality score for each candidate material; and
determining the optimal material based at least partially on the respective quality scores.

7. The system as recited in claim 1, the user interface comprising a plurality of selectable elements to enable selection of material information, manufacturing process information, and performance parameter information that is sent to the one or more processors via the user interface, wherein, upon receipt of the information related to at least one of the optimal material or the optimal manufacturing process, the user interface is update to present at least one of the information related to the optimal material information or the information related to the optimal manufacturing process.

8. A method comprising:
receiving, by a computing device, from a user device, inputs specifying a performance parameter and at least one of a material or a manufacturing process;
determining, by the computing device, at least one of a machine learning model or a simulation model corresponding to at least one manufacturing process related to the inputs;
inputting, by the computing device, information related to a plurality of candidate materials into the at least one of the machine learning model or the simulation model to determine a predicted property of respective candidate materials of the plurality of candidate materials, the predicted property related to the performance parameter;
comparing, by the computing device, the predicted properties of the respective candidate materials with each other to select at least one of a selected material or a selected manufacturing process based on the comparing; and
sending, by the computing device, to the user device, information related to the at least one of the selected material or the selected manufacturing process.

9. The method as recited in claim 8, wherein determining at least one of the machine learning model or the simulation model corresponding to the at least one manufacturing process related to the inputs further comprises:
based on determining that a machine learning model corresponding to the at least one manufacturing process related to the inputs is available, providing the input to the machine learning model; or
based on determining that the machine learning model corresponding to the at least one manufacturing process related to the inputs is not available, providing the input to the simulation model.

10. The method as recited in claim 9, based on the machine learning model being not available, the method further comprising:
following inputting the information to the simulation model, storing an output of the simulation model to a manufacturing database; and
training a new machine learning model related to the proposed manufacturing process based at least partially on the output of the simulation model.

11. The method as recited in claim 8, further comprising determining the plurality of candidate materials by searching, based on the inputs, at least one of a materials database or a manufacturing database to determine the plurality of candidate materials.

12. The method as recited in claim 8, comparing the predicted properties of the respective candidate materials further comprising:
determining, based at least partially on the predicted property, a quality value for each candidate material based on a prediction of the candidate material meeting the performance parameter; and
determining the optimal material based at least partially on determining the candidate material having a predicted property predicted to meet the performance parameter.

13. The method as recited in claim 8, wherein there are a plurality of the performance parameters received from the user device, the method further comprising:
determining a respective quality value for each candidate material for each performance parameter respectively, based on a prediction of the candidate material meeting the respective performance parameter;
applying a weighting factor to at least one quality value;
combining the quality values for each candidate material with the weighting factor applied to determine a respective quality score for each candidate material; and
determining the selected material based at least partially on the respective quality scores.

14. The method as recited in claim 8, further comprising:
receiving, by the computing device, the inputs via a user interface presented on the user device, the user interface comprising a plurality of selectable elements to enable selection of material information, manufacturing process information, and performance parameter information that is sent to the computing device via the user interface; and
the sending, by the computing device, to the user device, the information related to the at least one of the selected material or the selected manufacturing process causes the user device to, upon receipt of the information related to the at least one of the selected material or the selected manufacturing process, update the user interface to present at least one of the information related to the at least one of the selected material or the selected manufacturing process.

15. A computing device configured by executable instructions to perform operations comprising:
receiving, from a user device, inputs specifying a performance parameter and at least one of a material or a manufacturing process;
determining at least one of a machine learning model or a simulation model corresponding to at least one manufacturing process related to the inputs;
inputting information related to a plurality of candidate materials into the at least one of the machine learning model or the simulation model to determine a predicted property of respective candidate materials of the plurality of candidate materials, the predicted property related to the performance parameter;
comparing the predicted properties of the respective candidate materials with each other to select at least one of a selected material or a selected manufacturing process based on the comparing; and
sending, to the user device, information related to the at least one of the selected material or the selected manufacturing process.

16. The system as recited in claim 15, the operation of determining at least one of the machine learning model or the simulation model corresponding to the at least one manufacturing process related to the inputs further comprising:
based on determining that a machine learning model corresponding to the at least one manufacturing process related to the inputs is available, providing the input to the machine learning model; or
based on determining that the machine learning model corresponding to the at least one manufacturing process related to the inputs is not available, providing the input to the simulation model.

17. The system as recited in claim 16, based on the machine learning model being not available, the operations further comprising:
following inputting the information to the simulation model, storing an output of the simulation model to a manufacturing database; and
training a new machine learning model related to the proposed manufacturing process based at least partially on the output of the simulation model.

18. The system as recited in claim 15, the operation of comparing the predicted properties of the respective candidate materials further comprising:
determining, based at least partially on the predicted property, a quality value for each candidate material based on a prediction of the candidate material meeting the performance parameter; and
determining the optimal material based at least partially on determining the candidate material having a predicted property predicted to meet the performance parameter

19. The system as recited in claim 15, wherein there are a plurality of the performance parameters received from the user device, the operations further comprising:
determining a respective quality value for each candidate material for each performance parameter respectively, based on a prediction of the candidate material meeting the respective performance parameter;
applying a weighting factor to at least one quality value;
combining the quality values for each candidate material with the weighting factor applied to determine a respective quality score for each candidate material; and
determining the selected material based at least partially on the respective quality scores.

20. The system as recited in claim 15, the operation of sending, to the user device, information related to the at least one of the selected material or the selected manufacturing process comprising sending the information related to the at least one of the selected material or the selected manufacturing process to a manufacturing device to cause the manufacturing device to manufacture a product based on the information related to the at least one of the selected material or the selected manufacturing process.
